(19) United States
(12) Patent Application Publication
(10) Pub. No.: US 2021/0074015 A1
(43) Pub. Date: Mar. 11, 2021

(54) DISTANCE MEASURING DEVICE AND DISTANCE MEASURING METHOD

(71) Applicant: Mitsubishi Electric Corporation, Tokyo (JP)

(72) Inventor: Ken MIYAMOTO, Tokyo (JP)

(73) Assignee: Mitsubishi Electric Corporation, Tokyo (JP)

(21) Appl. No.: 16/640,319

(22) PCT Filed: Sep. 8, 2017
(86) PCT No.: PCT/JP2017/032494

§ 371 Date: Feb. 19, 2020

(51) Int. Cl. G06T 7/73; G06T 7/60

(52) U.S. Cl. CPC G06T 7/73; G06T 2207/10012; G06T 2207/10028; G06T 7/60

(57) ABSTRACT

A feature extracting unit (21) extracts multiple feature parts from an image. A position acquiring unit (23) acquires position information about feature parts specified on the image including the feature parts. A position correcting unit (24) corrects the position information acquired by the position acquiring unit (21) on the basis of pieces of position information about the multiple feature parts extracted by the feature extracting unit (23).

### TECHNICAL FIELD

The present disclosure relates to a position correcting device and a position correcting method.

### BACKGROUND ART

Conventionally, techniques for correcting position information specifying an object on an image to a correct position of the object have been known. The object is a point or a line in the image.

For example, in Patent Literature 1, a technique for correcting position information about a key that is specified from multiple keys (so-called software keys) displayed on a display unit by using a touch panel to a correct position of the key is described. In this technique, a relative position of a point of touch on a key, the touch being received using the touch panel, with respect to a reference position in a display area of the key is calculated for each of multiple keys. When a touch is received by the touch panel, on the basis of the point of this touch and the relative position of each of two or more keys existing within at least a certain range from the touch point, out of multiple keys, one of the two or more keys is determined as an operation target.

### CITATION LIST

### Patent Literature

Patent Literature 1: JP 2012-93948 A

### SUMMARY OF INVENTION

### Technical Problem

In the technique described in Patent Literature 1, the position information about the touch point, the position information specifying a key, can be corrected using reference positions in a known key display area.

However, a problem with the technique described in Patent Literature 1 is that because a nature image shot by a camera does not have a reference position for position correction as mentioned above, position information about an object specified on a nature image cannot be corrected.

The present disclosure is made in order to solve the above-mentioned problem, and it is therefore an object of the present disclosure to provide a position correcting device and a position correcting method capable of correcting position information even though an image does not have information serving as a reference for position correction.

### Solution to Problem

A position correcting device according to the present disclosure includes an image acquiring unit, a feature extracting unit, a display unit, a position acquiring unit, and a position correcting unit. The image acquiring unit acquires an image. The feature extracting unit extracts feature parts from the image acquired by the image acquiring unit. The display unit performs a process of displaying the image including the feature parts. The position acquiring unit acquires position information about the feature parts specified on the image including the feature parts. The position correcting unit corrects the position information acquired by the position acquiring unit on the basis of pieces of position information about the multiple feature parts extracted by the feature extracting unit.

### Advantageous Effects of Invention

According to the present disclosure, multiple feature parts are extracted from an image, position information about a feature part specified on the image including the feature parts is acquired, and the acquired position information is corrected on the basis of pieces of position information about the multiple feature parts extracted from the image. As a result, the position information can be corrected even though the image does not have information serving as a reference for position correction.

### BRIEF DESCRIPTION OF DRAWINGS

FIG. 1 is a block diagram showing the configuration of a distance measuring device including a position correcting device according to Embodiment 1 of the present disclosure;

FIG. 2 is a flow chart showing a position correcting method according to Embodiment 1;

FIG. 3 is a diagram showing an example of feature parts in an image;

FIG. 4A is a diagram showing an example of an image;

FIG. 4B is a diagram showing a situation in which points on corners are specified in the image;

FIG. 4C is a diagram showing the image on which the distance between the points on the corners is superimposed and displayed;

FIG. 5 is a block diagram showing the configuration of an augmented reality display device including a position correcting device according to Embodiment 2 of the present disclosure;

FIG. 6 is a flow chart showing a position correcting method according to Embodiment 2;

FIG. 7 is a diagram showing an overview of preprocessing;

FIG. 8 is a diagram showing an overview of an augmented reality displaying process;

FIG. 9A is a block diagram showing a hardware configuration for implementing the functions of the position correcting devices according to Embodiments 1 and 2; and

FIG. 9B is a block diagram showing a hardware configuration for executing software implementing the functions of the position correcting devices according to Embodiments 1 and 2.

### DESCRIPTION OF EMBODIMENTS

Hereafter, in order to explain the present disclosure in greater detail, embodiments of the present disclosure will be described with reference to the accompanying drawings. Embodiment 1.

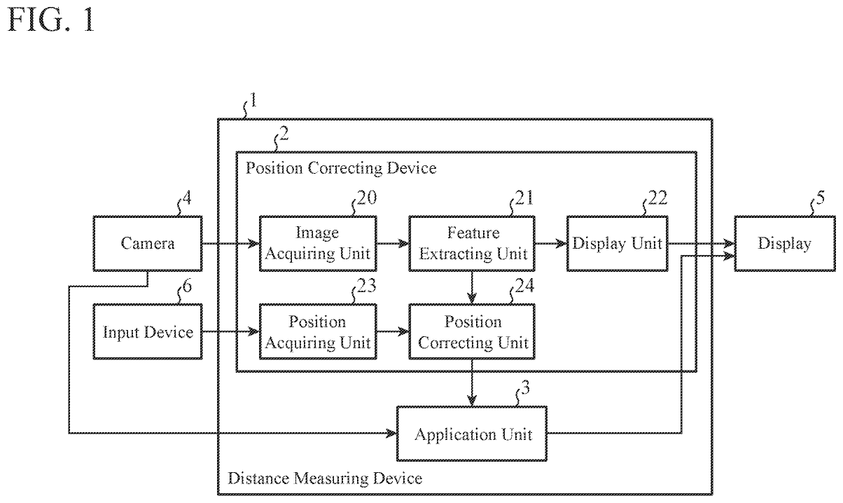

FIG. 1 is a block diagram showing the configuration of a distance measuring device 1 including a position correcting device 2 according to Embodiment 1 of the present disclosure. The distance measuring device 1 measures the distance between two objects specified on an image, and includes the position correcting device 2 and an application unit 3. Further, the distance measuring device 1 is connected to a camera 4, a display 5, and an input device 6. The position correcting device 2 corrects position information about an object that is specified on an image by using the input device 6, and includes an image acquiring unit 20, a feature extracting unit 21, a display unit 22, a position acquiring unit 23, and a position correcting unit 24.

The application unit 3 measures the distance between two objects on the basis of position information specifying each of the two objects on an image. As a method of measuring the distance between two objects, for example, a method of calculating the three-dimensional positions of the objects in real space from the two-dimensional positions of the objects on the image, and determining the distance between the three-dimensional positions of the two objects is provided. The position correcting device 2 corrects the two-dimensional position on the image of each object, which is used for the distance measurement of the application unit 3, to a correct position, for example.

The camera 4 shoots either a color image or a monochrome image as a nature image without information serving as a reference for position correction. Although the camera 4 may be a typical monocular camera, the camera 4 may be alternatively, for example, a stereoscopic camera capable of shooting images of a target from several different directions, or a time of flight (Tof) camera using infrared light.

The display 5 displays an image acquired through the correcting process by the position correcting device 2, an image acquired through the process by the application unit 3, or a shot image shot by the camera 4. As the display 5, for example, a liquid crystal display, an organic electroluminescence display (described as an organic EL display hereafter), or a head up display is provided.

The input device 6 receives an operation of specifying an object in an image displayed by the display 5. The input device 6, for example, includes a touch panel, a pointing device, or a sensor for gesture recognition.

The touch panel is disposed on the screen of the display 5, and receives a touch operation of specifying an object in an image. The pointing device receives an operation of specifying an object in an image by using a pointer, and is a mouse or the like. The sensor for gesture recognition recognizes a gesture operation of specifying an object, and recognizes a gesture operation by using a camera, infrared light, or a combination of a camera and infrared light.

The image acquiring unit 20 acquires an image shot by the camera 4. The image acquired by the image acquiring unit 20 is outputted to the feature extracting unit 21.

The feature extracting unit 21 extracts feature parts from the image acquired by the image acquiring unit 20. The feature parts are characteristic of the image, and are, for example, points on corners of an object to be shot, or lines of a contour part of an object to be shot.

The feature parts extracted by the feature extracting unit 21 and pieces of position information about the feature parts (their two-dimensional positions on the image) are outputted to the display unit 22 and the position correcting unit 24.

The display unit 22 performs a process of displaying the image including the feature parts. For example, the display unit 22 displays the image including the feature parts on the display 5.

Although the image including the feature parts may be an image acquired by the image acquiring unit 20, the image including the feature parts may be an image in which the feature parts in the image acquired by the image acquiring unit 20 are highlighted. A user of the distance measuring device 1 performs an operation of specifying either a point or a line on the image displayed on the display 5 by using the input device 6.

The position acquiring unit 23 acquires position information about a point or a line that is specified on the image by using the input device 6. For example, in the case in which the input device 6 is a touch panel, the position acquiring unit 23 acquires information about a position where a touch operation has been performed. In the case in which the input device 6 is a pointing device, the position acquiring unit 23 acquires a pointer position. In the case in which the input device 6 is a sensor for gesture recognition, the position acquiring unit 23 acquires a gesture operation position showing a feature part.

The position correcting unit 24 corrects the position information about a point or a line, the position information being acquired by the position acquiring unit 23, on the basis of the pieces of position information about the feature parts extracted by the feature extracting unit 21.

For example, when a point or a line is specified on the image through a touch operation, there is a case in which a deviation of several tens of pixels from the true position of the point or the line occurs. The reason why this deviation occurs is that the user's finger is much large, compared with each pixel of the image.

The position correcting unit 24 determines, as position information about a point or a line specified on the image, position information about the feature part that is closest to the position information, acquired by the position acquiring unit 23, regarding the point or the line, out of the pieces of position information about the multiple feature parts extracted from the image by the feature extracting unit 21.

Next, operations will be explained.

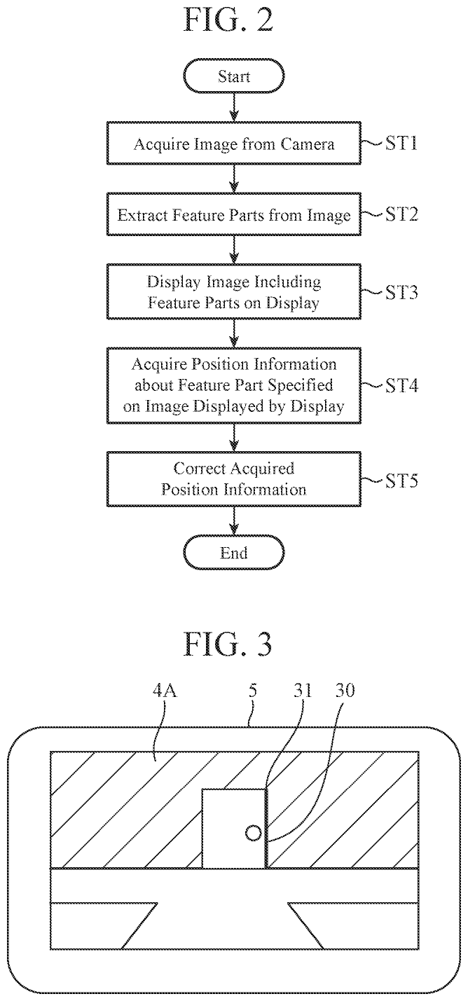

FIG. 2 is a flow chart showing a position correcting method according to Embodiment 1.

The image acquiring unit 20 acquires an image shot by the camera 4 (step ST1). The feature extracting unit 21 extracts feature parts from the image acquired by the image acquiring unit 20 (step ST2). For example, the feature extracting unit 21 extracts multiple characteristic points or lines out of the image.

FIG. 3 is a diagram showing feature parts in an image 4A. The image 4A is shot by the camera 4 and is displayed on the display 5. A rectangular door is seen, as an object to be shot, in the image 4A. The feature extracting unit 21 extracts, for example, either a line 30 corresponding to an edge of the door or a point 31 on a corner of the door, which is the object to be shot. The corner corresponds to an intersection at which edges cross each other.

The feature extracting unit 21 extracts characteristic points from the image by using, for example, a Harris corner detecting method. The feature extracting unit 21 alternatively extracts characteristic lines from the image by using, for example, a Hough transform.

The explanation is returned to FIG. 2.

The display unit 22 displays the image including the feature parts on the display 5 (step ST3).

For example, the display unit 22 receives the image acquired by the image acquiring unit 20 from the feature extracting unit 21, and displays the above-mentioned image on the display 5 just as it is.

Further, the display unit 22 may superimpose the above-mentioned feature parts on the image acquired by the image acquiring unit 20 and display the image on the display 5 after changing the colors of the feature parts extracted by the feature extracting unit 21 to emphasize the feature parts. A user of the distance measuring device 1 performs an operation of specifying a point or a line on the image by using the input device 6. For example, the user performs either an operation of touching a point in the image on the touch panel or an operation of tracing a line in the image.

The position acquiring unit 23 acquires position information about the point or the line that is specified on the image displayed by the display 5 by using the input device 6 (step ST4) . Herein, it is assumed that the above-mentioned position information shows a position y of the point or the line.

The position correcting unit 24 corrects the position information acquired by the position acquiring unit 23 on the basis of the pieces of position information about the feature parts extracted by the feature extracting unit 21 (step ST5).

For example, out of the points or the lines that are extracted as the feature parts by the feature extracting unit 21, the position correcting unit 24 determines the point or the line closest to the position y of the point or the line specified using the input device 6. The position correcting unit 24 then replaces the position of the point or the line specified using the input device 6 with the position of the determined point or line.

When a point is specified on the image displayed by the display 5, out of the N points extracted by the feature extracting unit 21, the position correcting unit 24 determines the point closest to the position y of the point specified using the input device 6 (the point with the shortest distance to the specified point) in accordance with the following equation (1) In the following equation (1) , xᵢ (i=1, 2, 3, . . . , and N) is the position of each point that is extracted from the image by the feature extracting unit 21.

$$arg {min}_{i ∈ N} {‖ {x}_{i} - y ‖}^{2} \qquad ( 1 )$$

When a line is specified on the image displayed by the display 5, out of the M lines extracted by the feature extracting unit 21, the position correcting unit 24 determines the line closest to the position y of the line specified using the input device 6 (the line with the shortest distance to the specified line) in accordance with the following equation (2). In the following equation (2), zⱼ (j==1, 2, 3, . . . , and M) is a vector of each line that is extracted from the image by the feature extracting unit 21, and x shows an outer product.

$$arg {min}_{j ∈ M} \frac{\vert {z}_{j} \times y \vert}{\vert {z}_{j} \vert} \qquad ( 2 )$$

When the series of processes shown in FIG. 2 is completed, the application unit 3 performs a distance measurement process on the basis of the position information corrected by the position correcting device 2.

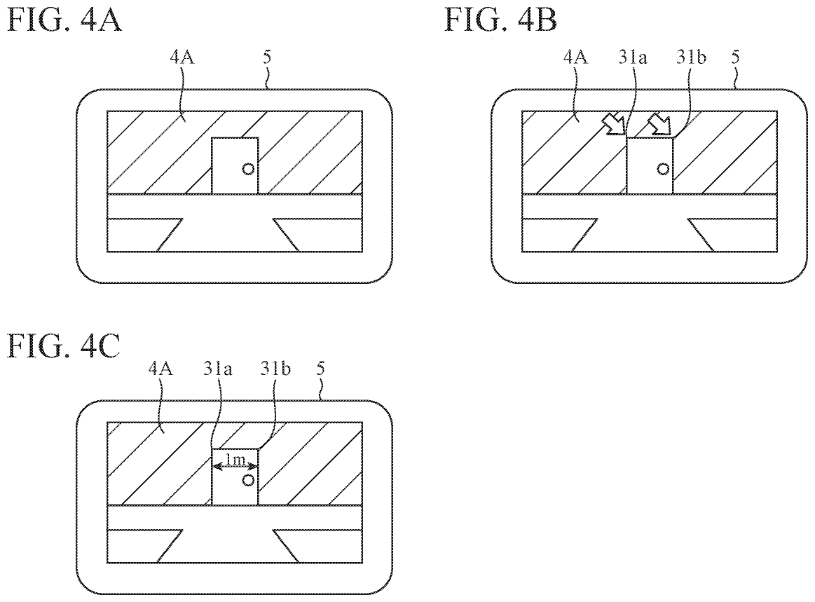

FIG. 4A is a diagram showing an image 4A shot by the camera 4, which is a nature image, and the image is displayed on the display 5. A rectangular door is seen as an object to be shot in the image 4A, just as in the case of FIG. 3.

FIG. 4B is a diagram showing a situation in which points 31a and 31b on corners are specified in the image 4A. A user of the distance measuring device 1 specifies each of the points 31a and 31b by using the input device 6. Because the points 31a and 31b are feature parts of the image 4A, the pieces of position information about the points 31a and 31b are corrected by the position correcting device 2.

FIG. 4C is a diagram showing the image 4A in which the distance between the points 31a and 31b on the corners is superimposed and displayed. The application unit 3 calculates the distance between the points 31a and 31b on the basis of the pieces of corrected position information about the points 31a and 31b.

For example, the application unit 3 converts the two-dimensional positions of the points 31a and 31b, the two-dimensional positions being corrected by the position correcting device 2, into three-dimensional positions of the points 31a and 31b in real space, and calculates the distance between the three-dimensional positions of the points 31a and 31b.

In FIG. 4C, the application unit 3 superimposes and displays text information showing “1 m” that is the distance between the points 31a and 31b on the image 4A displayed on the display 5.

As mentioned above, in the position correcting device 2 according to Embodiment 1, the image acquiring unit 20 acquires an image. The feature extracting unit 21 extracts multiple feature parts from the image acquired by the image acquiring unit 20. The display unit 22 performs a process of displaying the image including the feature parts. The position acquiring unit 23 acquires position information about a feature part specified on the image including the feature parts. The position correcting unit 24 corrects the position information acquired by the position acquiring unit 23 on the basis of pieces of position information about the feature parts extracted by the feature extracting unit 21. In particular, a point or a line in the image is extracted as each feature part. As a result, position information can be corrected even though an image does not have information serving as a reference for position correction. Further, because the position information about a feature part is corrected to a correct position by the position correcting device 2, the accuracy of the distance measurement function by the distance measuring device 1 can be improved.

### Embodiment 2

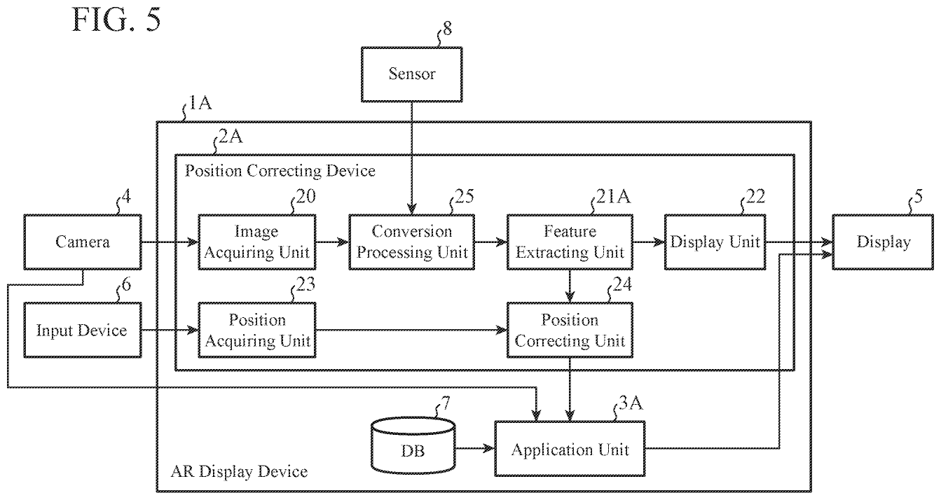

FIG. 5 is a block diagram showing the configuration of an augmented reality (described as AR hereafter) display device 1A including a position correcting device 2A according to Embodiment 2 of the present disclosure. In FIG. 5, the same components as those shown in FIG. 1 are denoted by the same reference signs, and an explanation of the components will be omitted hereafter.

The AR display device 1A displays AR graphics on an image displayed on a display 5, and includes the position correcting device 2A, an application unit 3A, and a database (described as DB hereafter) 7. Further, a camera 4, the display 5, an input device 6, and a sensor 8 are connected to the AR display device 1A.

The position correcting device 2A corrects position information specified using the input device 6, and includes an image acquiring unit 20, a feature extracting unit 21A, a display unit 22, a position acquiring unit 23, a position correcting unit 24, and a conversion processing unit 25.

On the basis of the position and the attitude of the camera 4, the application unit 3A superimposes and displays AR graphics on an image that is shot by the camera 4 and displayed on the display 5. Further, the application unit 3A calculates the position and the attitude of the camera 4 on the basis of both position information specified on the image displayed by the display 5 and the corresponding three-dimensional position in real space that is read from the DB 7.

In the DB 7, pieces of three-dimensional position information in a plane on which AR graphics are apparently displayed in real space are stored.

The sensor 8 detects an object to be shot whose image is shot by the camera 4, and is implemented by a distance sensor or a stereoscopic camera.

On the basis of detection information of the sensor 8, the conversion processing unit 25 converts an image acquired by the image acquiring unit 20 into an image in which a shooting direction is changed virtually.

For example, on the basis of the detection information of the sensor 8, the conversion processing unit 25 checks whether an object to be shot has been shot by the camera 4 from an oblique direction, and converts an image in which an object to be shot has been shot by the camera 4 from an oblique direction into an image in which the object to be shot is shot from the front.

The feature extracting unit 21A extracts feature parts from the image after conversion by the conversion processing unit 25.

Next, operations will be explained.

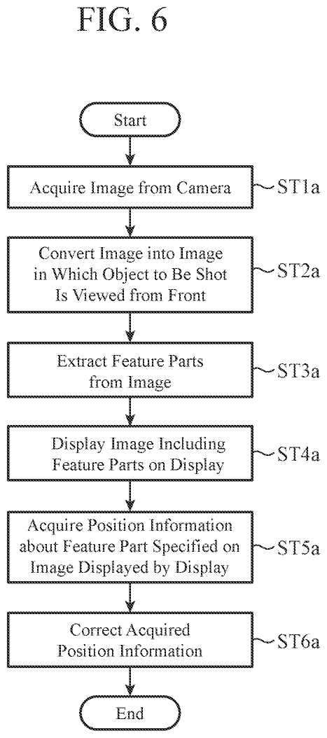

FIG. 6 is a flow chart showing a position correcting method according to Embodiment 2. Because processes in steps ST1a and ST4a to ST6a in FIG. 6 are the same as those in steps ST1 and ST3 to ST5 in FIG. 2, the explanation of the processes will be omitted.

In step ST2a, the conversion processing unit 25 converts an image acquired by the image acquiring unit 20 into an image in which an object to be shot is viewed from the front.

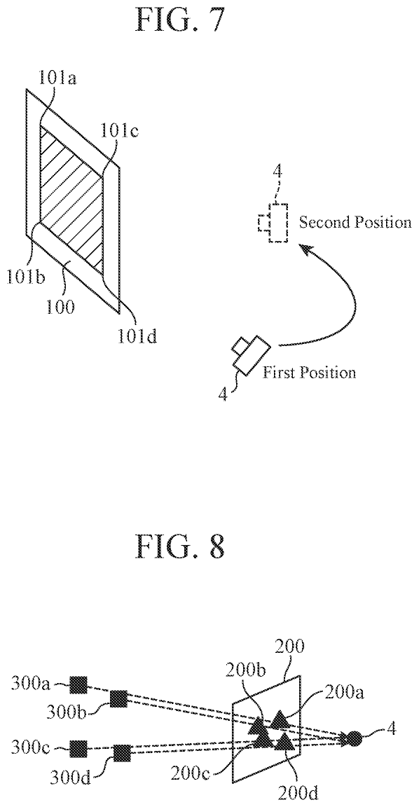

FIG. 7 is a diagram showing an overview of preprocessing. In FIG. 7, the object to be shot 100 shot by the camera 4 is a rectangular object, such as a road sign, having a flat part.

When the camera 4 is at a first position, the object to be shot 100 is shot by the camera 4 from an oblique direction, and is seen in the image shot by the camera 4 while being distorted into a rhombus.

A user of the AR display device 1A specifies, for example, points 101a to 101d on the image in which the object to be shot 100 is seen, by using the input device 6.

However, in the case of an image in which the object to be shot 100 is seen while being distorted, there is a high possibility that, for example, an edge of the object to be shot 100 becomes extremely short and this results in a failure in the extraction of the edge as a feature part, and there is also a possibility that its position cannot be correctly calculated.

Thus, in the AR display device 1A according to Embodiment 2, the conversion processing unit 25 converts an image that is shot by the camera 4 from an oblique direction into an image in which the object to be shot is viewed from the front.

For example, when the object to be shot 100 is a rectangular object having a flat part, the sensor 8 detects the distances between multiple points in the flat part of the object to be shot 100 and the camera 4 (first position). When the distances detected by the sensor 8 are gradually increasing along one direction of the object to be shot 100, the conversion processing unit 25 determines that the object to be shot 100 has been shot by the camera 4 from an oblique direction.

When determining that the object to be shot 100 has been shot by the camera 4 from an oblique direction, the conversion processing unit 25 converts the two-dimensional coordinates of the image in such a way that the distances between the multiple points in the flat part of the object to be shot 100 and the camera 4 become equal. More specifically, the conversion processing unit 25 performs conversion into an image in which the object to be shot 100 looks as if the object to be shot 100 were shot by the camera 4 at a second position from the front, by changing the rotation degree of the flat part of the object to be shot 100 with respect to the camera 4, thereby virtually changing the shooting direction of the camera 4.

In step ST3a, the feature extracting unit 21A extracts multiple feature parts from the image on which the preprocessing has been performed by the conversion processing unit 25. For example, the feature extracting unit 21A extracts multiple characteristic points or lines out of the image. Because the image on which the preprocessing has been performed is the one in which the distortion of the object to be shot 100 has been removed, a failure in the extraction of points or lines by the feature extracting unit 21A is reduced, which enables the correct calculation of the positions of points or lines.

Although in step ST4a, the display unit 22 may display the image on which the preprocessing has been performed on the display 5, the display unit may display the image acquired by the image acquiring unit 20 on the display 5 just as it is. Further, the display unit 22 may superimpose the above-mentioned feature parts on the image and display the image on the display 5 after changing the colors of the feature parts extracted by the feature extracting unit 21A to emphasize the feature parts.

Further, the case in which the conversion processing unit 25 performs conversion into an image in which the object to be shot 100 looks as if the object to be shot 100 were shot by the camera 4 from the front is shown, but not limited to this.

For example, because the conversion processing unit 25 virtually changes the shooting direction of the image as long as the change does not hinder the feature extracting unit 21A from extracting feature parts and calculating the positions of the feature parts, there can be a case in which the object to be shot is seen slightly slantwise in the image after the preprocessing.

When the series of processes shown in FIG. 6 is completed, the application unit 3A performs a process of displaying AR graphics on the basis of the position information corrected by the position correcting device 2A.

FIG. 8 is a diagram showing an overview of the process of displaying AR. An image shot by the camera 4 is projected onto an image projection plane 200 of the display 5.

A user of the AR display device 1A specifies points 200a to 200d on the image projected onto the image projection plane 200, by using the input device 6. The pieces of position information about the points 200a to 200d are corrected by the position correcting device 2A.

On the basis of the pieces of position information about the points 200a to 200d that have been corrected by the position correcting device 2A, the application unit 3A searches the DB 7 for three-dimensional position information corresponding to each of these pieces of position information. In FIG. 8, the three-dimensional positions of points 300a to 300d in real space correspond to the positions of the points 200a to 200d specified by the user.

Next, the application unit 3A calculates, as the position of the camera 4, the position at which vectors (arrows shown by broken lines in FIG. 8) extending from the points 300a to 300d in real space to the points 200a to 200d on the image converge, for example. Further, the application unit 3A calculates the attitude of the camera 4 on the basis of the calculated position of the camera 4.

The application unit 3A superimposes and displays AR graphics on the image shot by the camera 4 on the basis of the position and the attitude of the camera 4.

Although in Embodiment 2 the case in which the position correcting device 2A including the conversion processing unit 25 is disposed in the AR display device 1A is shown, the position correcting device 2A, instead of the position correcting device 2 shown in Embodiment 1, may be disposed in the distance measuring device 1. With this configuration, a failure in the extraction of feature parts by the feature extracting unit 21 is reduced, which enables the correct calculation of the positions of feature parts.

As mentioned above, the position correcting device 2A according to Embodiment 2 includes the conversion processing unit 25 that converts an image acquired by the image acquiring unit 20 into an image in which the shooting direction is changed virtually. The feature extracting unit 21A extracts multiple feature parts from the image after conversion by the conversion processing unit 25. With this configuration, a failure in the extraction of feature parts is reduced, which enables the correct calculation of the positions of feature parts.

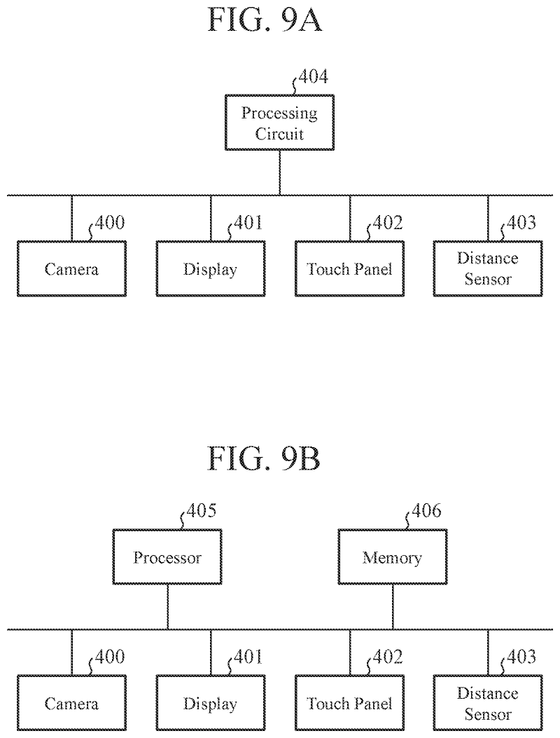

FIG. 9A is a block diagram showing a hardware configuration for implementing the functions of the position correcting device 2 and the position correcting device 2A. FIG. 9B is a block diagram showing a hardware configuration for executing software implementing the functions of the position correcting device 2 and the position correcting device 2A.

In FIGS. 9A and 9B, a camera 400 is a camera device such as a stereoscopic camera or a Tof camera, and is the camera 4 shown in FIGS. 1 and 5. A display 401 is a display device such as a liquid crystal display, an organic EL display, or a head up display, and is the display 5 shown in FIGS. 1 and 5. A touch panel 402 is an example of the input device 6 shown in FIGS. 1 and 5. A distance sensor 403 is an example of the sensor 8 shown in FIG. 5.

Each of the functions of the image acquiring unit 20, the feature extracting unit 21, the display unit 22, the position acquiring unit 23, and the position correcting unit 24 in the position correcting device 2 is implemented by a processing circuit.

More specifically, the position correcting device 2 includes a processing circuit for performing each process in the flow chart shown in FIG. 2.

The processing circuit may be either hardware for exclusive use or a central processing unit (CPU) that executes a program stored in a memory.

Similarly, each of the functions of the image acquiring unit 20, the feature extracting unit 21A, the display unit 22, the position acquiring unit 23, the position correcting unit 24, and the conversion processing unit 25 in the position correcting device 2A is implemented by a processing circuit.

More specifically, the position correcting device 2A includes a processing circuit for performing each process in the flow chart shown in FIG. 6.

The processing circuit may be either hardware for exclusive use or a CPU that executes a program stored in a memory.

In a case in which the processing circuit is hardware for exclusive use shown in FIG. 9A, the processing circuit 404 is, for example, a single circuit, a composite circuit, a programmable processor, a parallel programmable processor, an application specific integrated circuit (ASIC), a field-programmable gate array (FPGA), or a combination of these circuits.

In a case in which the processing circuit is a processor 405 shown in FIG. 9B, each of the functions of the image acquiring unit 20, the feature extracting unit 21, the display unit 22, the position acquiring unit 23, and the position correcting unit 24 is implemented by software, firmware, or a combination of software and firmware.

Similarly, each of the functions of the image acquiring unit 20, the feature extracting unit 21A, the display unit 22, the position acquiring unit 23, the position correcting unit 24, and the conversion processing unit 25 is implemented by software, firmware, or a combination of software and firmware. The software or the firmware is described as a program and the program is stored in a memory 406.

The processor 405 implements each of the functions of the image acquiring unit 20, the feature extracting unit 21, the display unit 22, the position acquiring unit 23, and the position correcting unit 24 by reading and executing a program stored in the memory 406.

More specifically, the position correcting device 2 includes the memory 406 for storing a program by which each process in the series of processes shown in FIG. 2 is performed as a result when the program is executed by the processor 405.

These programs cause a computer to perform procedures or methods that the image acquiring unit 20, the feature extracting unit 21, the display unit 22, the position acquiring unit 23, and the position correcting unit 24 have.

Similarly, the processor 405 implements each of the functions of the image acquiring unit 20, the feature extracting unit 21A, the display unit 22, the position acquiring unit 23, the position correcting unit 24, and the conversion processing unit 25 by reading and executing a program stored in the memory 406.

More specifically, the position correcting device 2A includes the memory 406 for storing a program by which each process in the series of processes shown in FIG. 2 is performed as a result when the program is executed by the processor 405.

These programs cause a computer to perform procedures or methods that the image acquiring unit 20, the feature extracting unit 21A, the display unit 22, the position acquiring unit 23, the position correcting unit 24, and the conversion processing unit 25 have.

The memory 406 is, for example, a non-volatile or volatile semiconductor memory, such as a random access memory (RAM), a read only memory (ROM), a flash memory, an erasable programmable read only memory (EPROM), or an electrically EPROM (EEPROM), a magnetic disc, a flexible disc, an optical disc, a compact disc, a mini disc, a DVD, or the like.

Some of the functions of the image acquiring unit 20, the feature extracting unit 21, the display unit 22, the position acquiring unit 23, and the position correcting unit 24 may be implemented by hardware for exclusive use, and some of the functions may be implemented by software or firmware.

Further, some of the functions of the image acquiring unit 20, the feature extracting unit 21A, the display unit 22, the position acquiring unit 23, the position correcting unit 24, and the conversion processing unit 25 may be implemented by hardware for exclusive use, and some of the functions may be implemented by software or firmware.

For example, the functions of the feature extracting unit 21 and the display unit 22 are implemented by the processing circuit 404 as hardware for exclusive use. The functions of the position acquiring unit 23 and the position correcting unit 24 may be implemented by the processor 405's reading and executing a program stored in the memory 406.

In this way, the processing circuit can implement each of the above-mentioned functions by using hardware, software, firmware, or a combination of hardware, software, and firmware.

The present disclosure is not limited to the above-mentioned embodiments, and any combination of two or more of the above-mentioned embodiments can be made, various changes can be made in any component according to any one of the above-mentioned embodiments, and any component according to any one of the above-mentioned embodiments can be omitted within the scope of the present disclosure.

### INDUSTRIAL APPLICABILITY

Because the position correcting device according to the present disclosure can correct position information even though an image does not have information serving as a reference for position correction, the position correcting device can be used for, for example, distance measuring devices or AR display devices.

### REFERENCE SIGNS LIST

1 distance measuring device, 1A AR display device, 2, 2A position correcting device, 3, 3A application unit, 4 camera, 4A image, 5 display, 6 input device, 8 sensor, 20 image acquiring unit, 21, 21A feature extracting unit, 22 display unit, 23 position acquiring unit, 24 position correcting unit, 25 conversion processing unit, 30 line, 31, 31a, 31b, 101a to 101d, 200a to 200d, 300a to 300d point, 100 object to be shot, 200 image projection plane, 400 camera, 401 display, 402 touch panel, 403 distance sensor, 404 processing circuit, 405 processor, and 406 memory.

1. A distance measuring device for measuring a distance in three-dimensional space, comprising:
processing circuitry to
acquire a two-dimensional image in which the three-dimensional space is shot;
extract multiple feature parts in the three-dimensional space and pieces of position information about the multiple feature parts on the two-dimensional image from the acquired two-dimensional image;
perform a process of displaying the two-dimensional image including the feature parts;
acquire position information specified by an input device on the two-dimensional image including the feature parts;
determine position information about a feature part on the two-dimensional image, the feature part being closest to the acquired position information, out of the extracted multiple feature parts, on a basis of the acquired position information;
convert the position information about the feature part on the two-dimensional image, the position information being determined, into a three-dimensional position; and
calculate a distance in the three-dimensional space between two feature parts on a basis of the three-dimensional position after conversion.

2. The distance measuring device according to claim 1,
Wherein the processing circuitry further converts the acquired two-dimensional image into a two-dimensional image in which a shooting direction in three-dimensional space is changed virtually,
wherein the processing circuitry extracts multiple feature parts in three-dimensional space and pieces of position information about the multiple feature parts on the two-dimensional image from the converted two-dimensional image.

3. The distance measuring device according to claim 1,
wherein the processing circuitry extracts points in the two-dimensional image as the feature parts in three-dimensional space.

4. The distance measuring device according to claim 1,
wherein the processing circuitry extracts lines in the two-dimensional image as the feature parts in three-dimensional space.

5. A distance measuring method of measuring a distance in three-dimensional space, comprising:
acquiring a two-dimensional image in which the three-dimensional space is shot;
extracting multiple feature parts in the three-dimensional space and pieces of position information about the multiple feature parts on the two-dimensional image from the acquired two-dimensional image;
performing a process of displaying the two-dimensional image including the feature parts;
acquiring position information specified by an input device on the two-dimensional image including the feature parts; and
determining position information about a feature part on the two-dimensional image, the feature part being closest to the acquired position information, out of the extracted multiple feature parts, on a basis of the acquired position information.

6. The distance measuring method according to claim 5, further comprising
converting the acquired two-dimensional image into a two-dimensional image in which a shooting direction in three-dimensional space is changed virtually; and
extracting multiple feature parts in three-dimensional space and pieces of position information about the multiple feature parts on the two-dimensional image from the converted two-dimensional image.

7. The distance measuring device according to claim 2,
wherein the processing circuitry extracts points in the two-dimensional image as the feature parts in three-dimensional space.

8. The distance measuring device according to claim 2,
wherein the processing circuitry extracts lines in the two-dimensional image as the feature parts in three-dimensional space.
